(19) United States
(12) Patent Application Publication
(10) Pub. No.: US 2017/0315508 A1
(43) Pub. Date: Nov. 2, 2017

(54) Push In Watch Crown Mechanism

(71) Applicant: Kevin Joseph Masone, Yorba Linda, CA (US)

(72) Inventor: Kevin Joseph Masone, Yorba Linda, CA (US)

(21) Appl. No.: 15/296,043

(22) Filed: Oct. 18, 2016

Related U.S. Application Data
(60) Provisional application No. 62/330,149, filed on May 1, 2016.

(51) Int. Cl. G04B 3/04

(52) U.S. Cl. CPC G04B 3/043

(57) ABSTRACT

A push in watch crown mechanism which allows a watch crown to be positioned inside the watch case while allowing the function of being released outside of the watch case to adjust the time of the watch. The watch crown mechanism is comprised of the watch crown, a spring used to release said watch crown out of the watch case, a release mechanism and a locking mechanism. The purpose of this push in watch crown mechanism is to allow the watch crown to sit completely flush inside the watch case, eliminating the watch crown from digging into the user's wrist while wearing the watch. This push in watch crown mechanism solves the common problem of the standard protruding watch crown causing discomfort and irritation to the user's wrist, and creates a more unique and comfortable watch to wear on the wrist.

### CROSS-REFERENCE TO RELATED APPLICATIONS

This application claims priority to U.S. Provisional Application No. 62/330,149 filed May 1, 2016, the entire contents of which are incorporated herein by reference.

### FIELD OF INVENTION

The present invention relates to a push in watch crown mechanism.

### BACKGROUND

A watch crown is the knob on the outside of the watch casing which is used to set the time of the watch and a variety of its functions. In a mechanical watch, the crown knob may be used to wind the mainspring. Standard watch crowns are located outside of the watch casing and protrude from the watch enabling the user to grip and pull the crown to adjust the time and other features on the watch. To operate the watch crown, the user will pull the knob outward away from the watch to adjust the time, and then push the crown back towards the watch to set the time.

The problem associated with standard watch crowns is the placement and functionality. The placement of a watch crown is located on the right side of the watch, if placed on the left arm, and on the left side of the watch if placed on the right arm. This is to allow the user to access the watch crown with the right hand when wearing the watch on the left, and vice versa, to adjust the time or features on the watch. The problem with the watch crown being located outside the watch case is that it is located right above the wrist and protrudes out of the watch case causing extreme discomfort and irritation when digging into the wrist or hand.

This invention eliminates all possibility of the protruding watch crown from digging into the hand or wrist, and allows the user to wear the watch more comfortably. Presently there is no solution for a push in watch crown mechanism that will eliminate this problem.

### SUMMARY

The present invention provides a solution to this problem by providing a push in watch crown mechanism that allows the crown to be pushed flush into the watch housing. Similar in regards to the function of a ball point mechanical pen, the watch crown can be pushed in to the housing, where said watch crown will click and sit flush inside the watch housing. Through the use of a deployment or release mechanism, the watch crown can be ejected from the watch housing, enabling the user to operate the watch crown to adjust the time and features. Another functioning aspect of the watch crown is a push button feature, which allows the user to push the crown into the case, then push it again to release it out of the watch case or housing.

Another purpose of this invention is design capabilities. Many watch crowns are designed to have a flush or built in look, which is highly regarded for the overall design of the watch. This invention allows the watch crown to be concealed flush into the watch housing, and with the push of a button, or by pushing the crown, will release the crown out of the case for use.

### DESCRIPTION OF DRAWINGS

FIG. A illustrates a standard watch case with the watch crown released outside the watch case.

FIG. B illustrates the watch crown pushed into the watch case, flush with the outside of the watch.

FIG. 1 illustrates the first watch crown mechanism locked inside the watch case, sitting flush with the housing.

FIG. 2 illustrates the first watch crown mechanism released and sitting outside the watch case.

FIG. 3 illustrates the first watch crown mechanism being pulled out to the right, enabling the crown to adjust the time and features on the watch.

FIG. 4 is a section view of the second watch crown mechanism.

FIG. 5 illustrates a link bar mechanism that locks onto the crown sleeve, thus the watch crown being inside the watch case.

FIG. 6 illustrates the link bar mechanism releasing the watch crown, by the use of a separate button, thus allowing the watch crown to be out of the watch case.

FIG. 7 illustrates the watch crown being pulled to the right, shown by the arrow, engaging the watch crown to pull the watch stem to adjust the time.

FIG. 8 illustrates the second watch crown mechanism locked inside the watch case, sitting flush with the housing.

FIG. 9 illustrates the second watch crown mechanism released and sitting outside the watch case.

FIG. 10 illustrates the second watch crown mechanism being pulled out to the right, enabling the crown to adjust the time and features on the watch.

### DETAILED DESCRIPTION

Described herein is a mechanism or method for a push in watch crown. The following description is presented to assist any person skilled in the art to make and use the invention as claimed and is provided in the context of the particular examples discussed below, variations of which will be apparent to those familiar with the art. In the interest of clearness, not all features of implementation are described in this description. Accordingly, the claims appended hereto are not intended to be limited by the disclosed embodiments, but are to be permitted their broadest scope consistent with the principles and features disclosed herein.

Figure A, located on page 1, shows a standard watch case with the watch crown released outside the watch case. This is an example of what a standard watch looks like with the crown locked into place. Figure B, located on page 1, shows the watch crown pushed into the watch case, flush with the outside of the watch. Figure A and Figure B represent the actual purpose or idea of the invention, which is a watch crown mechanism that will allow the protruding crown to be pressed into the watch case, then release out when needed to adjust the time or date of watch. The objective of the watch crown mechanism components described below ultimately allows for the purpose of the watch crown positioning in Figure B.

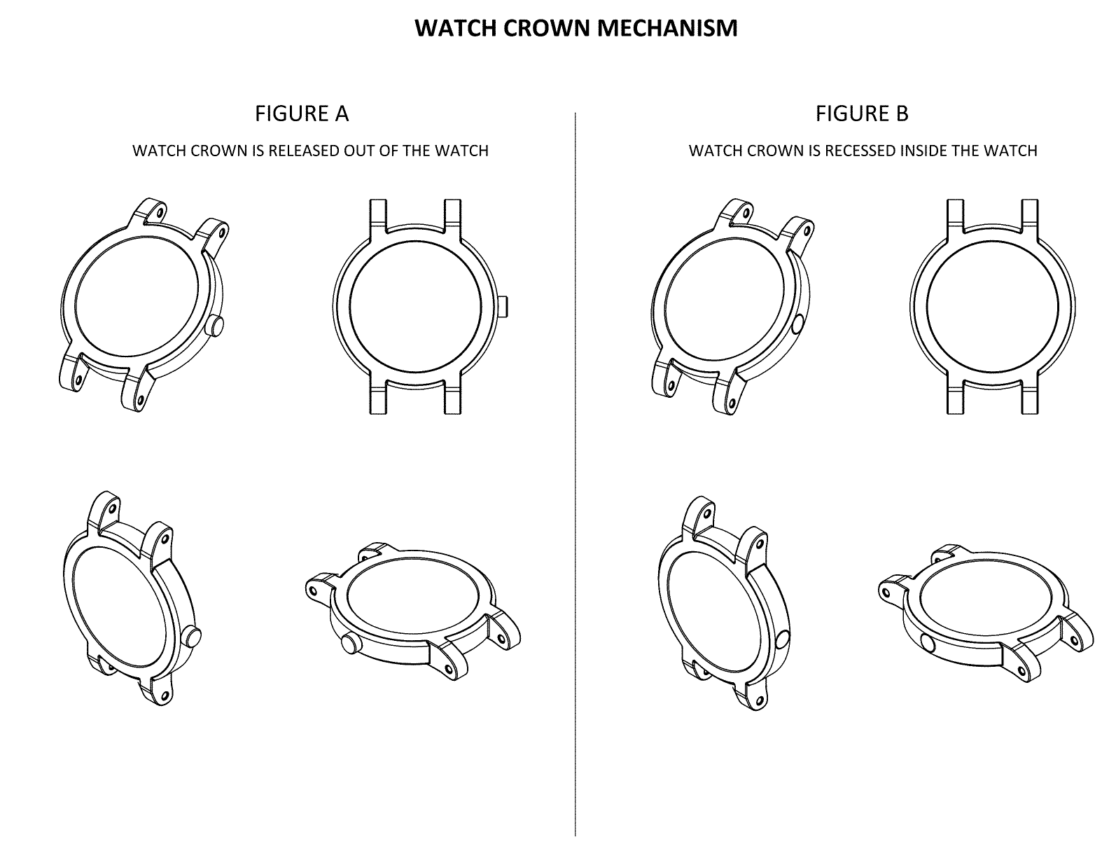

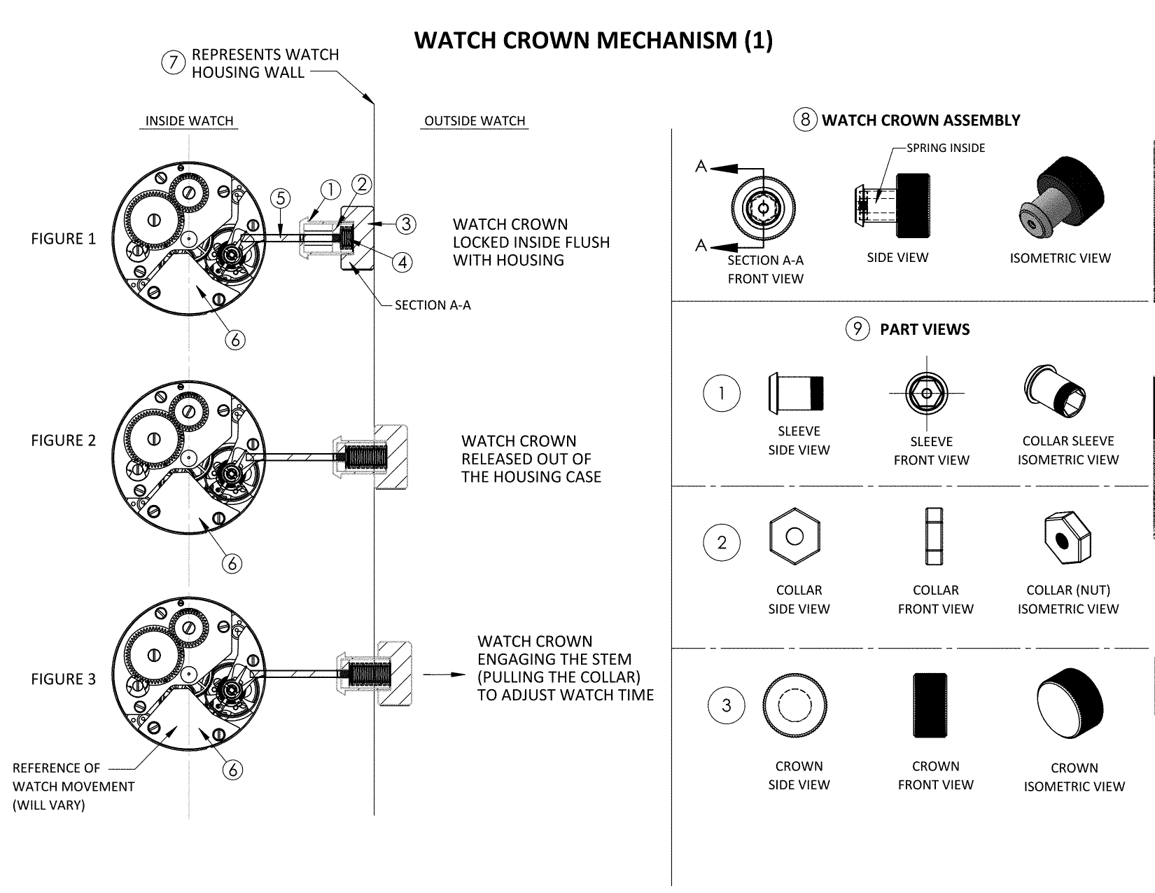

Page 2 represents one of the many possible mechanisms that will allow the watch crown mechanism to operate inside the watch case. FIG. 1 illustrates the watch crown locked inside the watch case, sitting flush with the housing. FIG. 2 illustrates the watch crown released and sitting outside the watch case. FIG. 3 illustrates the watch crown being pulled out to the right, enabling the crown to adjust the time and features on the watch. FIG. 1, FIG. 2 and FIG. 3 all represent the idea and basic function, not limiting to, and application of the watch crown mechanism. The watch movement 6, is not limited to size or function, and will vary based on the wide variety of watch movements.

To the right of page 2 are the basic components of the watch crown mechanism used in the system. The watch crown assembly 8, shows the completed watch crown assembly. Under part views 9, the sleeve 1 of the watch crown houses the collar 2. Said sleeve 1 is concentric with the watch stem 5 and assembled onto the standard watch stem 5 through the use of said collar 2. The watch stem 5 is the long, usually threaded, rod that when pulled away will be used to adjust the time of the watch movement. Similar in function to a nut on a bolt, said collar 2 screws onto said watch stem 5, which is used to engage said watch stem 5 to adjust time. Inside the sleeve 1, the walls are the same profile as the collar 2, so that they are locked while in rotation or torque movements, but will allow said collar 2 to slide through said sleeve 1 component. The watch crown 3 is the component that the user will push or pull to engage or set the watch time and attaches to the sleeve 1. Inside said sleeve 1, there is a spring that sits between the crown 3 and collar 2. The spring is used to release the crown out of the watch case. Likewise, other items that can store energy, such as a spring, may be used to replace the spring component. Section view A-A, located in FIG. 1, represents the section view of the watch crown assembly 8.

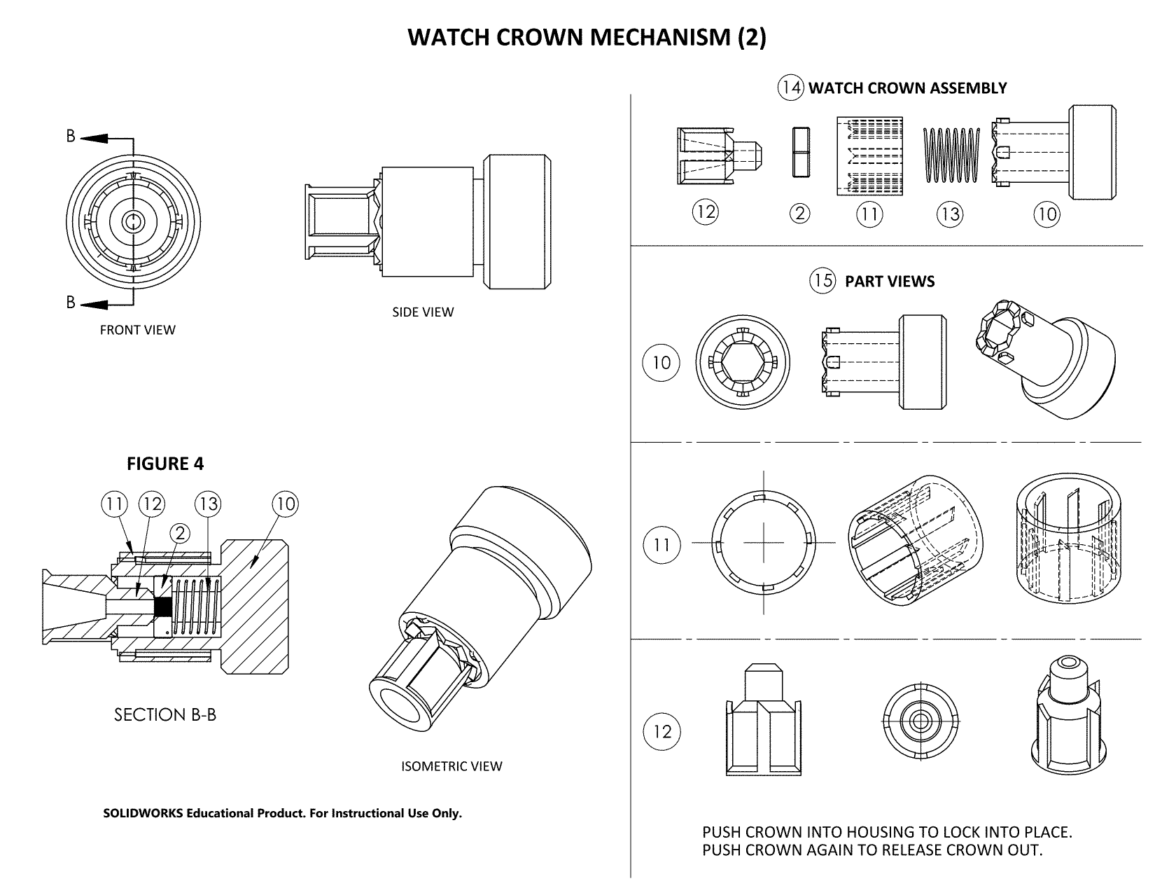

Page 3 represents a push in watch crown assembly and the components that make up the assembly. FIG. 4 represents the section view of the completed assembly with the parts listed. The part assembly 14 is shown in regards to the order of components of the assembly. There are, but not limited to, five main components that make up the push in watch crown assembly. The first component in the parts view 15 is the watch crown 10. Similar in regards and function to the watch crown 3 and the sleeve 1 on page 2, the watch crown 10 is a combination of said watch crown 3 and said sleeve 1. The inside of the watch crown 10 is the same profile as the walls of the collar 2. The watch crown 10 has guiding pins, or protruding grooves, on the outside that interlock or fit with the inside grooves of the push in housing 11. The push in housing 11 will remain stationary inside the watch case. The release mechanism 12 allows the watch crown 10 to be released out of the watch case through the guidance of the grooves inside the push in housing 11. Said release mechanism 12 comes in contact with the collar 2, shown in the section view B-B in FIG. 4. The spring is located inside the watch crown 10 and in direct contact with the collar 2. The watch crown 10 is used to pull the collar 2, which said collar 2 is connected to the watch stem 5, which engages the watch movement to set the time. By pushing the watch crown 10 into the watch case, the push in housing 11 grooves will lock the watch crown 10 into the case. Through the use of an addition manual push by the user, the watch crown 10 will be release through the use of the push in housing 11 and the release mechanism 12. This push release mechanism, similar in relation to a mechanical click pen, allows the user to push the crown into the housing to lock the crown into place, then by pushing the crown a second time releases the crown out of the watch case.

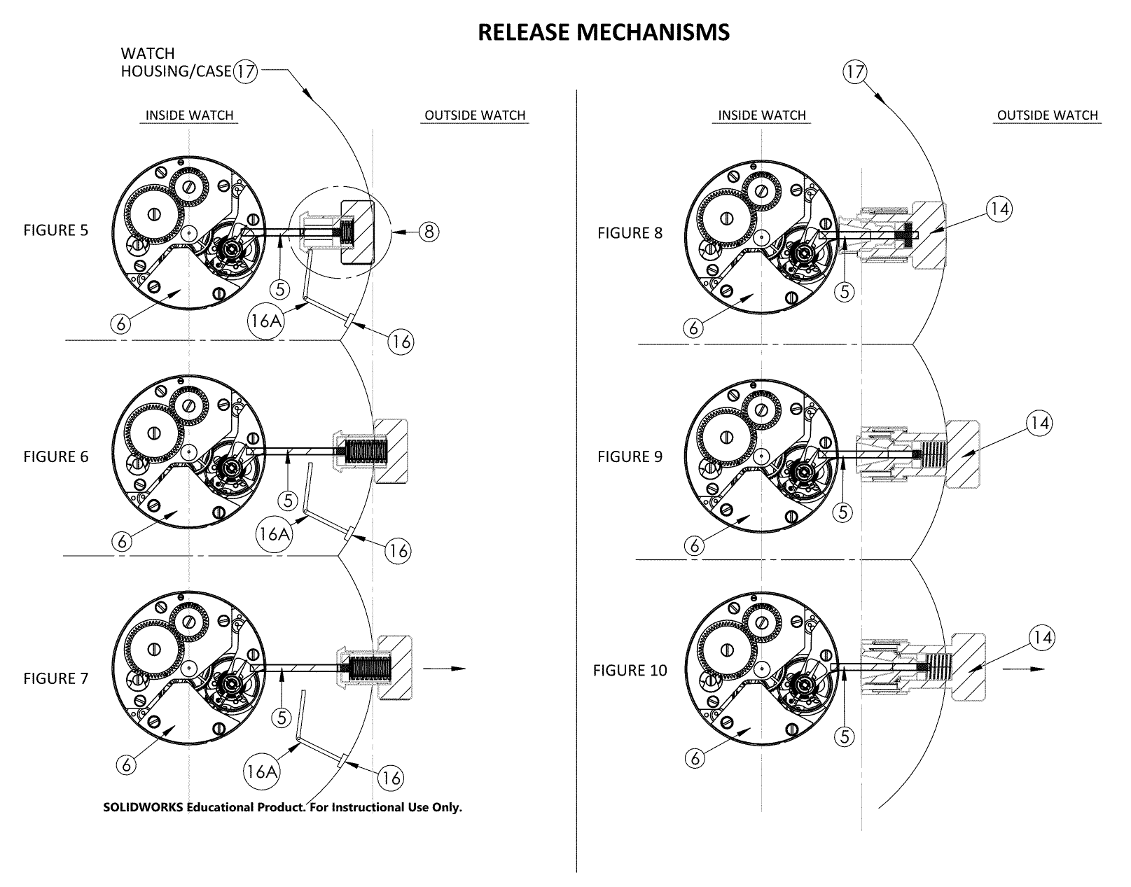

Page 4 represents the two, but not limited to, release mechanisms described above. FIG. 5 illustrates the first watch crown mechanism on page 2, with a release link mechanism 16A to release the watch crown assembly 8. Through the use of an external button 16, said button 16 will trigger the link bar mechanism 16A, which will then release the watch crown assembly 8 out of the watch case. FIG. 6 is a representation showing the trigger release mechanism 16A with the watch crown assembly 8 released out of the watch housing/case 17. FIG. 7 illustrates the watch crown assembly 8 being pulled to the right away from the watch housing/case 17, shown by the arrow, engaging said watch crown assembly 8 to pull the watch stem 5 to adjust the time. FIG. 8 illustrates the second watch crown mechanism on page 2, with the watch crown assembly 14 locked inside the watch case, sitting flush with the housing. FIG. 9 illustrates the watch crown assembly 14 released and sitting outside the watch case. FIG. 10 illustrates the watch crown assembly 14 being pulled out to the right, enabling the crown to adjust the time and features on the watch.

The invention described has a wide variety of manufacturing processes or materials that can be used. One applicable manufacturing process to make the components would be by machining, manual milling or lathes, or CNC machines. The second way is part casting or injection molding using different alloys or plastics. Different materials can be used for each part. Ideally, stainless steel, or an alloy can be used, although plastic may be an option for most parts.

Furthermore, there are several different mechanisms that can be used to hold and release a watch crown in a watch. Various changes in the details of the illustrated mechanisms are possible without departing from the scope of the following claims. The scope of the invention should, therefore, be determined with reference to the appended claims, along with the full scope of the equivalents to which such claims are entitled. It is understood that the description given is merely by way of illustration and not in limitation of the invention and that various modifications may be made thereto without departing from the spirit of the invention as claimed.

Prior art U.S. Pat. No. US2004100869 (A1), “Push-piece control device for a watch”, issued May 27, 2004, Finazzi Pierre-Andre discloses a push piece control device for a watch which comprises the main aspect of an integral watch crown. Throughout the patent, a lever is commonly described as the function of said watch crown, which is concentrically to the push piece. Common in regards to the resulting function described such as setting the date, time and other mechanical features, the push piece control device is merely located outside the watch case with a “stirrup-shaped piece straddling the crown and the push piece” which are both located outside of the watch.

Prior art U.S. Pat. No. JPH07198863 (A), “PUSH PIECE CROWN FOR TIMEPIECE”, issued Aug. 1, 1995, Mishie and Pari claim a push piece crown which is fixed on a watch control winding stem. Similar with regards to a spring used to return the watch crown, said watch crown is fixed outside the watch case. The push piece crown feature is located outside the watch case for every aspect of what is claimed. Prior art U.S. Pat. No. US 20140362673 A1, “Watch with enclosed crown”, issued Dec. 11, 2014, David Earl claims a watchcase for housing the movement, the stem, and the crown. Ultimately his main focus throughout the claims is represented through the use of a body configuration comprising of a lid which are threaded and screwed together as a mate. Claim 15 describes the method of setting the time of the watch through the use of the watch crown by “unscrewing the body and the lid from each other;”, then “extending the crown away from the movement until the hands are disengaged from the movement;”, next “rotating the hands or the crown;”, following “moving the crown back towards the movement until the hands are re-engaged with the movement;”, then lastly finally “screwing the body and the lid together to form a water-resistant enclosure.” The whole method of enclosing the watch crown into the watch case can only be executed by removing the body from the lid then screwing the lid back onto the body to form a water resistant enclosure.

1. A push in watch crown mechanism comprising:
a watch crown;
a spring or equivalent system to store energy used to release the watch crown out of the watch case; and
a watch stem used to set the features of the watch such as the date and time.

2. The push in watch crown mechanism of claim 1 wherein:
the watch crown can be pushed inside the watch case, whereas the watch crown will not be protruding out of the watch case; and
the watch crown can be released out of the watch case to be used to pull the crown to set the features of the watch.

3. The push in watch crown mechanism of claim 1 wherein the watch crown pulls the watch stem to change the features of the watch.

4. The push in watch crown mechanism of claim 1 wherein the watch crown mechanism has a release mechanism capable of allowing the watch crown to be released or ejected out of the watch case.

5. The push in watch crown mechanism of claim 1 wherein the watch crown mechanism has a locking mechanism capable of allowing the watch crown to be pushed back into the watch case and positioned inside the watch case.

6. The push in watch crown mechanism of claim 1 wherein the watch crown comprises a spring, or any other equivalent system which stores energy, enabling to push the watch crown out of the watch case to adjust the time and features of the watch.

7. The push in watch crown mechanism of claim 1 wherein the watch crown will be positioned inside the watch case, and can be released out of the watch case to adjust the features of the watch.
